(19) United States
(12) Patent Application Publication
(10) Pub. No.: US 2023/0028595 A1
(43) Pub. Date: Jan. 26, 2023

(54) ANALYSIS FUNCTION IMPARTING DEVICE, ANALYSIS FUNCTION IMPARTING METHOD, AND ANALYSIS FUNCTION IMPARTING PROGRAM

(71) Applicant: NIPPON TELEGRAPH AND TELEPHONE CORPORATION, Tokyo (JP)

(72) Inventors: Toshinori USUI, Musashino-shi, Tokyo (JP); Tomonori IKUSE, Musashino-shi, Tokyo (JP); Yuhei KAWAKOYA, Musashino-shi, Tokyo (JP); Makoto IWAMURA, Musashino-shi, Tokyo (JP); Jun MIYOSHI, Musashino-shi, Tokyo (JP)

(73) Assignee: NIPPON TELEGRAPH AND TELEPHONE CORPORATION, Tokyo (JP)

(21) Appl. No.: 17/764,988

(22) PCT Filed: Oct. 11, 2019
(86) PCT No.: PCT/JP2019/040336

§ 371 Date: Mar. 30, 2022

(51) Int. Cl. G06F 21/56; G06F 11/36; G06F 9/455

(52) U.S. Cl. CPC G06F 21/56; G06F 11/3688; G06F 9/455

(57) ABSTRACT

An analysis function imparting device (10) includes a virtual machine analyzing unit (121) that analyzes a virtual machine of a script engine, a command set architecture analyzing unit (122) that analyzes a command set architecture that is a command system of the virtual machine, and an analysis function imparting unit (123) that performs hooking for imparting multipath execution functions to the script engine, on the basis of architecture information acquired by the analysis performed by the virtual machine analyzing unit (121) and the command set architecture analyzing unit (122).

### TECHNICAL FIELD

The present invention relates to an analysis function imparting device, an analysis function imparting method, and an analysis function imparting program.

### BACKGROUND ART

Various forms of attacks are being generated, such as spam using malware (malspam), fileless malware, and so forth, and the threat of attack by script exhibiting malicious behavior (malicious script) therein is becoming apparent.

A malicious script is a script that has behavior with malicious intent, and is a program that realizes an attack by misusing functions provided by a script engine. Generally, attacks are carried out using script engines that particular applications have, such as a script engine that an operating system (OS) has in default, a Web browser, a document file viewer, and so forth.

Although many such script engines require user permission in some cases, behavior through the system can also be realized, such as file operation, network communication, activation of processes, and so forth. Accordingly, attacks using malicious script are a threat to users in the same way as attacks using execution file malware.

In order to take measures against attacks by such malicious script, the behavior of the script needs to be accurately comprehended. Accordingly, a technology that uncovers the behavior of script by analyzing the script is awaited.

A problem in analyzing malicious script is obfuscation of the code. Many malicious scripts have been subjected to processing called obfuscation, in order to interfere with analysis. Obfuscation makes analysis of code based on superficial information to be difficult, by intentionally increasing the complexity of the code. That is to say, obfuscation interferes with an analysis technique called static analysis, in which information acquired from the code is used for analysis, without executing the script.

Particularly, in a case of dynamically acquiring part of the code to execute from an external source, this code cannot be acquired without being executed, and accordingly cannot be statically analyzed. Thus, static analysis is impossible in principle.

Conversely, a technique called dynamic analysis where a script is executed and how the script behaves is monitored, thereby finding the behavior thereof, is not affected by the aforementioned obfuscation. Accordingly, techniques based on dynamic analysis are primarily used in analysis of malicious script.

In general dynamic analysis, malicious script is executed in an analyzing environment, and the behavior thereof is monitored, thereby acquiring only the behavior regarding a single execution path out of the malicious script executed. Accordingly, there is a problem in that behavior on paths not executed in the analysis environment cannot be acquired.

In other words, there is a problem that not all behavior can be completely analyzed for malicious script having paths executed only under particular conditions, even by dynamic analysis.

Examples of cases where there are paths only executed under particular conditions include cases where a subsequent execution path is decided by instructions from an instruction server, and cases where analysis interference has been implemented so that no malicious behavior is exhibited under an analyzing environment.

The former is a case in which no subsequent execution path is decided unless there is an instruction from an instruction server, and thus no path having malicious behavior is executed. It is not unusual for the attacker to have already retreated and the instruction server is gone at the time of detecting and analyzing malicious script. Accordingly, malicious behavior cannot be observed in such cases.

The latter is analysis inference where the malicious script acquires information of the environment in which it is being executed, and does not exhibit malicious behavior unless the environment satisfies particular conditions. For example, in a case of characteristics often found in analyzing environments being found, this is used for analyzing interference by the script, in which the script judges that it is being analyzed and interrupts execution.

FIG. 18 is a diagram illustrating a code piece that exhibits an example of analysis interference. This code piece has analysis interference of acquiring the number of CPU (Central Processing Unit) cores in the environment that it is being executed, judges that the probability of an analyzing environment is high unless the number is no less than two and no more than eight, and quits execution. Otherwise, judgment is made that the environment is not an analyzing environment, and malicious behavior is exhibited.

In order to capture the behavior of a path that is only executed under such particular conditions, multipath execution for executing a plurality of execution paths is necessary.

In multipath execution, when execution reaches conditional branching, the execution state is branched, and each execution state into which the execution state is branched following the respective execution paths of the branching. Thus, both of two execution paths occurring at conditional branching are executed.

With regard to realization of multipath execution, for example, NPL 1 describes a technique for realizing symbolic execution, which is a type of multipath execution, regarding JavaScript (a registered trademark). According to this technique, executable paths are comprehensively followed at conditional branching in JavaScript script, and behavior can be observed.

Also, NPL 2 discloses a technique for realizing forced path execution, which is a type of multipath execution, regarding JavaScript. According to this technique, all paths are comprehensively followed at conditional branching of script in JavaScript, and behavior can be observed.

NPL 3 describes a technique in which a script engine is manually converted in advance, and thereafter this script engine is executed on a binary-oriented symbolic execution platform, thereby realizing symbolic execution via the script engine, on the script being executed on the script engine. According to this technique, as long as there is a script engine that can be manually converted, versatile symbolic execution can be realized for any script language, executable paths are comprehensively followed, and behavior can be observed.

NPL 4 describes a technique for analyzing a virtual machine (VM) that malware often uses for obfuscation of its own programs. According to this technique, analyzing the VM enables architecture information thereof to be acquired. The VM governs execution of script in a script engine, and accordingly the concept of this technique can be partially applied.

### CITATION LIST

### Non Patent Literature

[NPL 1] Prateek Saxena, et al, “A Symbolic Execution Framework for JavaScript”, 2010 IEEE Symposium on Security and Privacy.

### [NPL 2] Kyungtae Kim, et al, “J-Force: Forced Execution on JavaScript”.

### [NPL 3] Stefan Bucur, et al, “Prototyping Symbolic Execution Engines for Interpreted Languages”.

### [NPL 4] Monirul Sharif, et al, “Automatic Reverse Engineering of Malware Emulators”, 2009 30th IEEE Symposium on Security and Privacy.

### SUMMARY OF THE INVENTION

### Technical Problem

However, the techniques described in NPL 1 and NPL 2 have a problem in that separate multipath execution functions have to be designed and implemented for each script engine. Also, the techniques described in NPL 1 and NPL 2 have a problem in that information of the architecture of the VM of the script engine needs to be known in advance, in order to realize multipath execution functions.

Also, the technique described in NPL 3 has a problem as well, in that information of the architecture of the VM of the script engine needs to be known in advance, since conversion of the script engine is necessary. Also, the technique described in NPL 3 has a problem in that detailed architecture, such as the scheme for conditional branching within the script engine, is not taken into consideration, and accordingly fine-grated multipath execution regarding script is difficult.

Acquisition of architecture information of the script engine requires analysis work. While this can be realized by source code analysis for open-source script engines, script languages with source code available are limited, and require a certain amount of man-hours. Further, proprietary script engines require reverse engineering of the binary, necessitating experienced reverse engineers and a great amount of man-hours for manual implementation, and accordingly is not practical. Further, automation of such reverse engineering is not established as of yet.

Further, the technique described in NPL 4 has a problem in that the object thereof is only the VM that the malware has, and the VMs that script engines have are not the object, and thus is not directly applicable to script engines. Also, the technique described in NPL 4 has a problem in that there is no mention of acquisition of architecture information relating to conditional branching, which is important for multipath execution. Moreover, the technique described in NPL 4 has a problem in that the focus is only on analysis of the VM, and function impartation to the VM, such as impartation of multipath execution, is not taken into consideration.

The present invention has been made in light of the foregoing, and accordingly it is an object thereof to provide an analysis function imparting device, an analysis function imparting method, and an analysis function imparting program, that can realize impartation of multipath execution functions to a script engine without prior architecture information.

### Means for Solving the Problem

In order to solve the above-described problem and achieve the object, an analysis function imparting device according to the present invention includes a first analyzing unit that analyzes a virtual machine of a malicious script engine, a second analyzing unit that analyzes a command set architecture that is a command system of the virtual machine, and an imparting unit that performs hooking for imparting multipath execution functions to the script engine, on the basis of architecture information acquired by the analysis performed by the first analyzing unit and the second analyzing unit.

An analysis function imparting method according to the present invention is an analysis function imparting method executed by an analysis function imparting device. The method includes a first analyzing process of analyzing a virtual machine of a malicious script engine, a second analyzing process of analyzing a command set architecture that is a command system of the virtual machine, and an imparting process of performing hooking for imparting multipath execution functions to the script engine, on the basis of architecture information acquired in the analysis performed in the first analyzing process and the second analyzing process.

Also, an analysis function imparting program according to the present invention causes a computer to execute a first analyzing step of analyzing a virtual machine of a malicious script engine, a second analyzing step of analyzing a command set architecture that is a command system of the virtual machine, and an imparting step of performing hooking for imparting multipath execution functions to the script engine, on the basis of architecture information acquired in the analysis performed in the first analyzing process and the second analyzing process.

### Effects of the Invention

According to the present invention, impartation of multipath execution functions to a script engine can be realized without prior architecture information.

### BRIEF DESCRIPTION OF DRAWINGS

FIG. 1 is a diagram for describing an example of a configuration of a script engine.

FIG. 2 is a diagram showing pseudocode of a VM that the script engine has.

FIG. 3 is a diagram for describing an example of a configuration of an analysis function imparting device according to an embodiment.

FIG. 4 is a diagram showing an example of test script (first test script) used for interpreter loop detection and virtual program counter detection.

FIG. 5 is a diagram showing an example of test script (second test script) used for branching VM command detection.

FIG. 6 is a diagram showing an example of execution traces.

FIG. 7 is a diagram showing an example of VM execution traces.

FIG. 8 is a flowchart showing processing procedures of analysis function imparting processing according to the embodiment.

FIG. 9 is a flowchart showing processing procedures of execution trace acquiring processing shown in FIG. 8.

FIG. 10 is a flowchart showing processing procedures of interpreter loop detecting processing shown in FIG. 8.

FIG. 11 is a flowchart showing processing procedures of virtual program counter detecting processing shown in FIG. 8.

FIG. 12 is a flowchart showing processing procedures of decoder/dispatcher detecting processing shown in FIG. 8.

FIG. 13 is a flowchart showing processing procedures of conditional branching flag detecting processing shown in FIG. 8.

FIG. 14 is a flowchart showing processing procedures of VM execution trace acquiring processing shown in FIG. 8.

FIG. 15 is a flowchart showing processing procedures of branching VM command detecting processing shown in FIG. 8.

FIG. 16 is a flowchart showing processing procedures of analysis function imparting processing shown in FIG. 8.

FIG. 17 is a diagram illustrating an example of a computer in which an analysis function imparting device is realized by a program being executed.

FIG. 18 is a diagram showing a code piece showing an example of analysis interference.

### DESCRIPTION OF EMBODIMENTS

An embodiment of analysis function imparting device, an analysis function imparting method, and an analysis function imparting program, according to the present application, will be described below in detail with reference to the drawings. Note that the present invention is not limited by the embodiment described below.

### EMBODIMENT

The analysis function imparting device according to the embodiment detects, by performing analysis of the binary of the script engine using a test script, an interpreter loop, a virtual program counter (VPC), a decoder/dispatcher, a conditional branching flag, and a branching command of the VM (branching VM command), in that order.

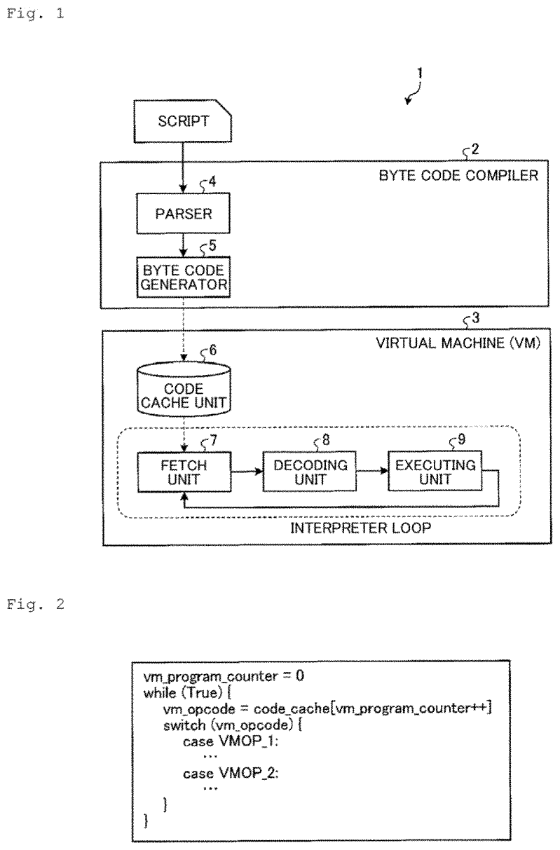

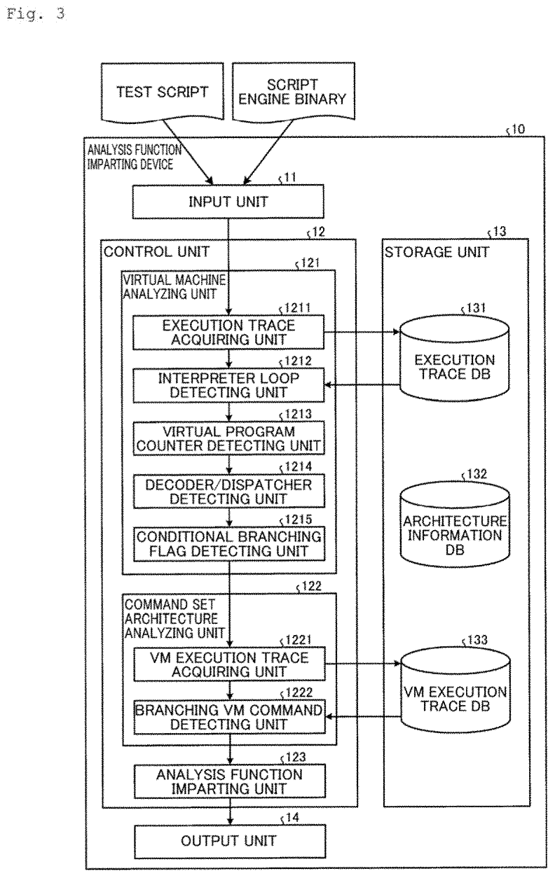

Note that these are all components of the script engine, and are information relating to architecture. The configuration of a general script engine, and the operations thereof, will be described with reference to FIG. 1 and FIG. 2.

FIG. 1 is a diagram for describing an example of a configuration of a script engine. As illustrated in FIG. 1, a script engine 1 has a byte code compiler 2 and a virtual machine (VM) 3. Also, the byte code compiler 2 has a parser 4 and a byte code generator 5. The VM 3 also has a code cache unit 6, a fetch unit 7, a decoding unit 8, and an executing unit 9. The fetch unit 7, the decoding unit 8, and the executing unit 9 are repeatedly executed, and are referred to as an interpreter loop. The script engine 1 accepts input of script.

The parser 4 receives script as input, and through lexical analysis and parsing, generates an abstract syntax tree (AST), which is output to the byte code generator 5. The byte code generator 5 receives the AST as input, converts this into byte code, and stores it in the code cache unit 6.

The fetch unit 7 fetches VM opcode from the code cache unit 6, and outputs to the decoding unit 8. Note that VM opcode means an opcode portion for VM commands. The decoding unit 8 receives the VM opcode as input, interprets the VM opcode using a decoder/dispatcher, and dispatches to a corresponding program. The executing unit 9 executes a program corresponding to the VM command. The VM commands are sequentially executed by repetition of the interpreter loop, thereby executing content described in the script.

Operations of the components of the script engine will be described with reference to FIG. 2. FIG. 2 is a diagram showing pseudocode of the VM that the script engine has. As illustrated in FIG. 2, the pseudocode first initializes the VPC (line 1). In the pseudocode, the while statement loop is the interpreter loop (line 2). In the pseudocode, the VM opcode that the VPC points to is acquired from code cache (line 3), and decoding and dispatching are performed using a Switch statement (lines 4, 5, and 7). Then in the pseudocode, programs corresponding to the VM opcode at the dispatch destination are executed (lines 6 and 8).

Also, a branching VM command is a VM command to cause a branch in the script, and a conditional branching flag is a region holding a flag regarding whether or not branching will be performed at the time of conditional branching.

[Analysis Function Imparting Device]
First, an analysis function imparting device 10 according to the present embodiment acquires an execution trace made up of a branch trace and a memory access trace, by branching command hooking and memory operation command hooking, regarding a malicious script engine binary. Note that the branch trace is a record of executed branching, and the memory access trace is a record of reading from and writing to memory that has been executed.

This analysis function imparting device 10 analyzes the execution trace, and detects an interpreter loop. An analysis technique called difference execution analysis, in which analysis based on difference among a plurality of execution traces acquired with different conditions at the time of execution is performed, is applied to detection of the interpreter loop. At this time, the conditions at the time of execution are changed by using different test scripts. The difference execution analysis used here takes note of the number of times of branching. The contents of the interpreter loop acquired here are the objects of subsequent analysis.

Also, this analysis function imparting device 10 analyzes the execution trace, and detects a VPC. The analysis function imparting device applies difference execution analysis that takes note of the number of times of memory rear-in for detection of the VPC.

Further, the analysis function imparting device 10 performs static analysis of the binary of the script engine, and detects the decoder/dispatcher. As a presumption, the decoder/dispatcher is realized as a Switch statement, or a jump table or function table. A technique of detecting table jumping using such as a Switch statement, or a jump table or function table, by static analysis, is commonly known, and accordingly the analysis function imparting device 10 detects these by a predetermined method.

The analysis function imparting device 10 then analyzes the execution trace and detects a conditional branching flag. For detection of the conditional branching flag, the analysis function imparting device 10 applies difference execution analysis that takes note of the memory read-in.

Next, the analysis function imparting device 10 acquires a VM execution trace by monitoring of the VPC and monitoring of the decoder/dispatcher VM opcode regarding the script engine binary. Note that the VM execution trace is a record of executed VM opcodes and VPCs.

The analysis function imparting device 10 analyzes this VM execution trace, and detects branching VM commands. In the detection of the branching VM command, the analysis function imparting device 10 first executes a great number of test scripts, and acquires VM execution traces. The analysis function imparting device 10 then collects the VM opcode and the amount of change in the VPC before and after execution thereof as a set, from the VM execution traces. In a case in which the VM opcode is other than a branching VM command, the amount of change in the VPC will be approximately constant. Conversely, in a case in which the VM opcode is of a branching VM command, the VPC will vary, depending on the branching destination. The analysis function imparting device 10 evaluates the degree of varying in the amount of change in the VPC for each VM opcode by variance, and detects those of which the variance is no less than a certain threshold value as being branching VM commands.

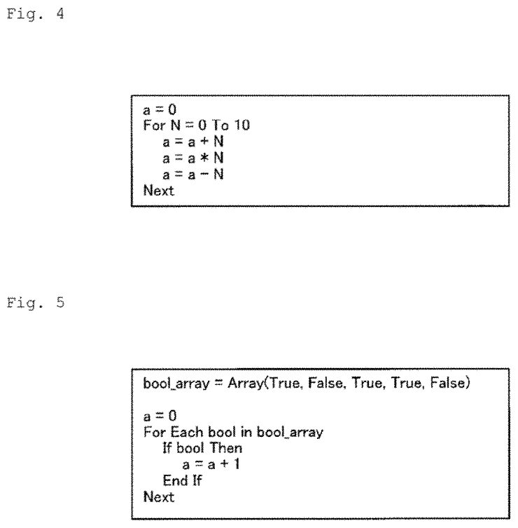

The analysis function imparting device 10 then performs hooking to the binary of the script engine, on the basis of the VPC, the branching VM command, and the conditional branching flag, acquired so far. Using this hook, the analysis function imparting device 10 monitors the destination that the VPC points to, and when this is a branching VM command, causes branching of the execution state. The analysis function imparting device 10 then performs execution of one execution state without change, and rewrites the conditional branching flag for the other execution state and then executes it. Accordingly, both execution paths of the conditional branch are executed. Thus, the analysis function imparting device 10 realizes retrofit imparting of multipath functions to the scrypt engine.

[Configuration of Analysis Function Imparting Device]
Next, the configuration of the analysis function imparting device 10 according to the embodiment will be described in detail with reference to FIG. 3. FIG. 3 is a diagram describing an example of the configuration of the analysis function imparting device according to the embodiment.

As illustrated in FIG. 1, the analysis function imparting device 10 has an input unit 11, a control unit 12, a storage unit 13, and an output unit 14. The analysis function imparting device 10 then accepts input of test scripts and script engine binary.

The input unit 11 is configured of an input device such as a keyboard, a mouse, and so forth, and accepts external input of information, which is input to the control unit 12. The input unit 11 accepts input of the test scripts and the script engine binary, and outputs the test scripts and the script engine binary to the control unit 12. Test scripts are scripts input when performing dynamic analysis of the script engine and acquiring execution traces and VM execution traces. Note that details of test scripts will be described later. The script engine binary is an executable file that configures the script engine. There are cases where the script engine binary is configured of a plurality of executable files.

The control unit 12 has internal memory for storing programs defining various types of processing procedures and so forth, and necessary data, and executes various types of processing using these. For example, the control unit 12 is an electronic circuit such as a CPU (Central Processing Unit), an MPU (Micro Processing Unit), or the like. The control unit 12 has a virtual machine analyzing unit 121 (first analyzing unit), a command set architecture analyzing unit 122 (second analyzing unit), and an analysis function imparting unit 123 (imparting unit).

The virtual machine analyzing unit 121 analyzes the VM of the script engine. The virtual machine analyzing unit 121 acquires a plurality of execution traces under different conditions at the time of execution, and uses difference execution analysis to analyze the plurality of execution traces, thereby acquiring the VPC and the conditional branching flag. The virtual machine analyzing unit 121 has an execution trace acquiring unit 1211 (first acquiring unit), an interpreter loop detecting unit 1212 (first detecting unit), a virtual program counter detecting unit 1213 (second detecting unit), a decoder/dispatcher detecting unit 1214 (third detecting unit), and a conditional branching flag detecting unit 1215 (fourth detecting unit).

The execution trace acquiring unit 1211 accepts test scripts and the script engine binary as input. The execution trace acquiring unit 1211 executes the test scripts while monitoring the execution of the script engine binary, thereby acquiring execution traces.

Execution traces are configured of branch traces and memory access traces. Branch traces record the types of branch commands at the time of execution, and branch source addresses and branching destination addresses. Memory access traces record the types of memory operations, and memory addresses that are the object of operations. Branch traces and memory access traces are known to be acquirable by command hooks. Execution traces acquired by the execution trace acquiring unit 1211 are stored in an execution trace DB 131.

The interpreter loop detecting unit 1212 extracts and analyzes an execution trace corresponding to the first test script, stored in the execution trace DB 131, and detects the interpreter loop. The interpreter loop detecting unit 1212 uses the fact that a branch of which the branching destination is the start of an interpreter loop is generated without fail after execution of each VM command, and detects the interpreter loop by discovering this branching destination.

Accordingly, the interpreter loop detecting unit 1212 uses difference execution analysis that takes note of the number of times of branching, for detection of the interpreter loop. The interpreter loop detecting unit 1212 compares the execution traces of the plurality of test scripts in which the number of repetitions thereof and the number of statements being repeated are different, and discovers a branching destination of which the number of times of branching is proportionate to both the number of repetitions thereof and the number of statements being repeated. The interpreter loop detecting unit 1212 detects this branching destination as the head of the interpreter loop.

The virtual program counter detecting unit 1213 extracts and analyzes an execution trace corresponding to the first test script stored in the execution trace DB 131, and detects the VPC. The virtual program counter detecting unit 1213 uses the fact that reading into memory storing the VPC occurs without fail after execution of each VM command, and detects the VPC by discovering this read-in destination.

Accordingly, the virtual program counter detecting unit 1213 uses difference execution analysis that takes note of the number of times of memory read-in, for detection of the VPC. The virtual program counter detecting unit 1213 compares the execution traces of the plurality of test scripts acquired using the same test scripts as those used for detection of the interpreter loop, and discovers memory of which the number of times of memory read-in is proportionate to both the number of repetitions thereof and the number of statements being repeated. The virtual program counter detecting unit 1213 detects this memory as the VPC.

The decoder/dispatcher detecting unit 1214 detects Switch statements, function tables, and jump tables present within the interpreter loop, by predetermined static analysis of the script engine binary. The decoder/dispatcher detecting unit 1214 detects a command sequence of such processing as the decoder/dispatcher.

The conditional branching flag detecting unit 1215 extracts and analyzes the execution trace corresponding to the second test script stored in the execution trace DB 131, and discovers the conditional branching flag. The conditional branching flag detecting unit 1215 analyzes a plurality of execution traces using difference execution analysis that takes note of the number of times of memory read-in, and detects the conditional branching flag. The conditional branching flag detecting unit 1215 executes conditional branching under various patterns, and compares patterns in change of memory at that time with the patterns of conditional branching in the test scripts, thereby detecting the memory for storing the conditional branching flag.

The command set architecture analyzing unit 122 analyzes the command set architecture that is the command system of the VM. The command set architecture analyzing unit 122 has a VM execution trace acquiring unit 1221 (second acquiring unit) and a branching VM command detecting unit 1222 (fifth detecting unit).

The VM execution trace acquiring unit 1221 accepts test scripts and the script engine binary as input, the same as the execution trace acquiring unit 1211. The VM execution trace acquiring unit 1221 executes the test scripts while monitoring executing of the script engine binary, thereby acquiring VM execution traces that are execution traces executed on the VM.

VM execution traces are configured of VPCs and VM opcodes for each VM command executed. Recording of VPCs can be realized by monitoring memory of VPCs detected by the virtual program counter detecting unit 1213. Recording of VM opcodes can be realized by monitoring VM opcodes input to the decoder detected by the decoder/dispatcher detecting unit 1214. The VM execution trace acquiring unit 1221 stores the acquired VM execution traces in a VM execution trace DB 133.

The branching VM command detecting unit 1222 extracts and analyzes the VM execution traces stored in the VM execution trace DB 133, and detects branching VM commands. The branching VM command detecting unit 1222 takes note of the difference in the degree of varying in VPC values between branching VM commands and other VM commands, decides a threshold value, and detects those with greater varying in VPC values as being branching VM commands. The branching VM command detecting unit 1222 detects branching VM commands by the varying change amounts of virtual program counters for each VM opcode of the VM execution traces.

The analysis function imparting unit 123 performs hooking for imparting multipath execution functions to the script engine, on the basis of architecture information acquired by the analysis performed by the virtual machine analyzing unit 121 and the command set architecture analyzing unit 122. The analysis function imparting unit 123 performs hooking to the script engine using the obtained VPC, branching VM command, and conditional branching flag. This hook is a hook for monitoring the VPC and confirming for VM opcode, and if the VM opcode is for a branching VM command, causing the execution state to branch. This hook is a hook that performs execution of one execution state without change, and rewrites the conditional branching flag for the other execution state and then executes it, thereby imparting multipath execution functions to the script engine.

The storage unit 13 is realized by a semiconductor memory device such as RAM (Random Access Memory), Flash Memory or the like, or a storage device such as a hard disk, optical disc, or the like, and stores processing programs for operating the analysis function imparting device 10, data used while executing the processing programs, and so forth. The storage unit 13 has the execution trace database (DB) 131, the VM execution trace DB 133, and an architecture information DB 132.

The execution trace DB 131 and the VM execution trace DB 133 store the execution traces and the VM execution traces acquired by the execution trace acquiring unit 1211 and the VM execution trace acquiring unit 1221, respectively. The execution trace DB 131 and the VM execution trace DB 133 are managed by the analysis function imparting device 10. The execution trace DB 131 and the VM execution trace DB 133 may be managed by another device (server or the like), as a matter of course. In this case, the execution trace acquiring unit 1211 and the VM execution trace acquiring unit 1221 output the acquired execution traces and VM execution traces to the managing server or the like of the execution trace DB 131 and the VM execution trace DB 133 via a communication interface of the output unit 14. The execution trace acquiring unit 1211 and the VM execution trace acquiring unit 1221 then store the acquired execution traces and VM execution traces in the execution trace DB 131 and the VM execution trace DB 133.

The output unit 14 is a liquid crystal display or a printer or the like, for example, and outputs various types of information including information relating to the analysis function imparting device 10. The output unit 14 may also be an interface that governs input/output of various types of data with an external device, and may output various types of information to the external device.

[Configuration of Test Script]
Description will be made regarding test script. Test script is script input at the time of performing dynamic analysis of a script engine. This test script takes note of the number of times of execution of branching commands and of reading from and writing to memory, and is used to capture difference in the behavior of the script engine generated when test scripts of different numbers of times are executed. The test script is prepared in advance to analysis, and is manually created. Knowledge regarding the specifications of the relevant script language is necessary for this creation.

FIG. 4 is a diagram showing an example of a test script (first test script) used for interpreter loop detection and VPC detection. Repetition processing is used in the first test script (line 2). In the first test script, the number of repetitions within the test script (line 2) and the number of statements repeated (line 3 to line 5) are increased/decreased, thereby changing conditions at the time of execution, and generating difference.

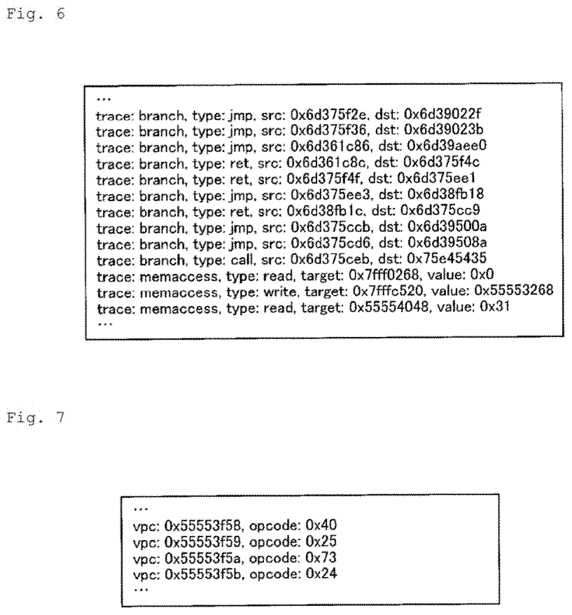

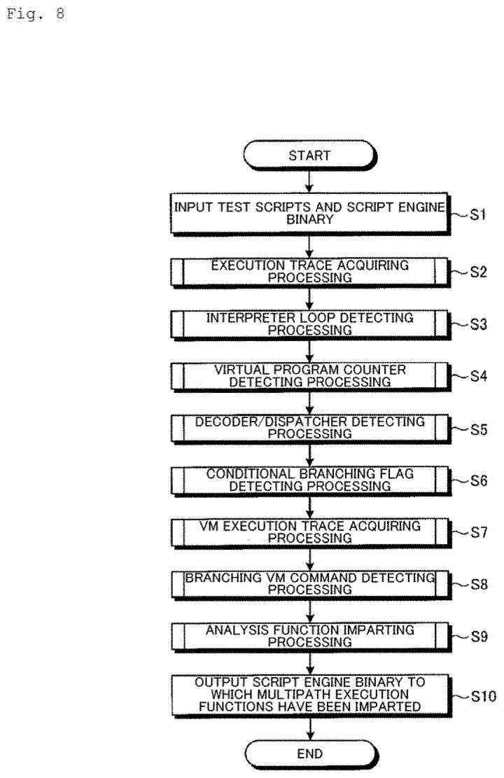

FIG. 5 is a diagram showing an example of a test script used for branching VM command detection (second test script). A plurality of times of conditional branches is used in the second test script (line 4 through line 8). In the second test script, branching conditions are controlled in the plurality of times of conditional branching, so that branching is performed and not performed according to a pattern in a particular order (line 1, line 5). In the second test script, the number of times of conditional branching and the order pattern of whether or not to branch, are changed, generating difference.

[Configuration of Execution Trace]
Next, description will be made regarding execution traces. FIG. 6 is a diagram showing an example of an execution trace. Execution traces are configured of branch traces and memory access traces, as described earlier. FIG. 6 is a diagram showing an example of an execution trace. The configuration of an execution trace will be shown below with reference to FIG. 6.

The execution trace has an element called a trace. A trace indicates whether that log line is a branch trace or a memory access trace.

A log line of a branch trace has a format such as described in line 1 through line 10 in FIG. 6, for example, and is made up of three elements of type, src, and dst. type indicates whether an executed branching command is from a call command, from a jmp command, or from a ret command. Also, src indicates the address of the branching source, and dst indicates the address of the branching destination.

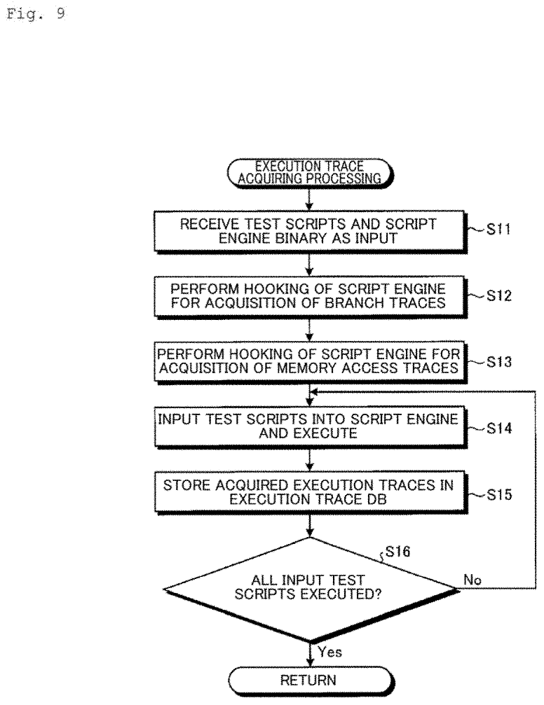

A log line of a memory access trace has a format such as described in line 11 through line 13 in FIG. 6, for example, and is made up of three elements of type, target, and value. type indicates whether the memory access is read or write. target indicates the memory address that is the object of the memory access. Also, a value of the result of memory access is stored in value.

[Configuration of VM Execution Trace]
Next, description will be made regarding VM execution traces. FIG. 7 is a diagram showing an example of a VM execution trace. AVM execution trace has recorded therein VM opcodes and VPCs, as described earlier. FIG. 7 is a partial extraction of an VM execution trace. The configuration of the VM execution trace will be described below with reference to FIG. 7.

A log line of a VM execution trace has a format such as described in FIG. 7, for example, and is made up of two types of elements, which are vpc and opcode. vpc indicates the value of a VPC. Also, opcode indicates the value of a VM opcode.

[Processing of Interpreter Loop Detecting Unit]
Next, the processing of the interpreter loop detecting unit 1212 will be described. Detection of an interpreter loop is realized by analyzing logs of branch traces in acquired execution traces. In an interpreter loop, generally a branching command causes a jump to the start of the loop following execution of a VM command. Accordingly, the interpreter loop detecting unit 1212 detects, from branching destination addresses in branch commands in branch traces, those that correspond to the start of an interpreter loop. The interpreter loop detecting unit 1212 uses difference execution analysis that takes note of the number of times of branching.

The interpreter loop detecting unit 1212 uses an execution trace corresponding to the first test script. The number of times of branching to the start of the interpreter loop is proportionate to the number of times of repeats in the test script, and the number of statements in the repeating processing. With the number of times of repeating as N, and the number of statements repeated as M, generally around MN branches to the start of the interpreter loop are generated. Accordingly, in execution traces corresponding to the first test script in which N and M are each increased to 2 N and 2 M, and 3 N and 3 M, the interpreter loop detecting unit 1212 detects branching destinations where increase such as 4 MN or 9 MN is exhibited, as the start of the interpreter loop.

[Processing of Virtual Program Counter Detecting Unit]
Next, the processing of the virtual program counter detecting unit 1213 will be described. Detection of a virtual program counter is realized by analyzing logs of memory access traces in acquired execution traces. A VPC is usually stored in memory, and is read in each time a VM command is executed, and accordingly reading of values into this memory address is generating. Accordingly, the virtual program counter detecting unit 1213 detects, from addresses that are the object of memory read-in in memory access traces, those that correspond to a VPC. The virtual program counter detecting unit 1213 uses difference execution analysis that takes note of the number of times of memory read-in.

The virtual program counter detecting unit 1213 uses an execution trace corresponding to the first test script. The number of times of read-in of the VPC is proportionate to the number of times of repeats in the test script, and the number of statements in the repeating processing. With the number of times of repeating as N, and the number of statements repeated as M, generally around MN VPC read-ins are generated. Accordingly, in execution traces corresponding to the first test script in which N and M are each increased to 2 N and 2 M, and 3 N and 3 M, the interpreter loop detecting unit 1212 detects memory where increase such as 4 MN or 9 MN is exhibited, as VPCs.

[Processing of Decoder/Dispatcher Detecting Unit]
Next, the processing of the decoder/dispatcher detecting unit 1214 will be described. The decoder/dispatcher detecting unit 1214 detects the decoder/dispatcher by static analysis of the binary of the script engine by a predetermined technique.

There generally are two types of implementation of a decoder/dispatcher. The first type of implementation of a decoder/dispatcher is implementation using a Switch statement, and the second type is implementation by table jumping using a function table or jump table. It is commonly known that recognition of Switch statements and table jumping can be realized by an already-existing static analysis technique. Accordingly, out of Switch statements and table jumping detected by the predetermined static analysis technique, the decoder/dispatcher detecting unit 1214 detects those existing within an interpreter loop as being a decoder/dispatcher.

[Processing of Conditional Branching flag Detecting Unit]
Next, the processing of the conditional branching flag detecting unit 1215 will be described. The conditional branching flag detecting unit 1215 detects conditional branching flags by analyzing memory access within an interpreter loop.

The conditional branching flag detecting unit 1215 uses execution traces obtained using the second test script. The conditional branching flag detecting unit 1215 detects conditional branching flags by performing two-stage narrowing down from memory access within an interpreter loop. A conditional branching flag has two states, which are branched and not branched. Also, conditional branching flag conceivably are read in for a number of times proportionate to the number of times of conditional branching.

Accordingly, as the first stage of narrowing down, the conditional branching flag detecting unit 1215 extracts memory that has a number of memory read-in proportionate to the number of times of conditional branching. Then, as the second stage of narrowing down, the conditional branching flag detecting unit 1215 extracts memory in which the values at the time of each memory read-in go back and forth between two values correlated with the conditional branching of the test script.

For example, in a case where a conditional branching flag holds a case of branching as X and a case of not branching as Y, the pattern of order of conditional branching in the second test script in FIG. 5 is branched, not branched, branched, branched, not branched. Accordingly, the conditional branching flag detecting unit 1215 extracts a memory address going back and forth between the two values of X, Y, X, X, Y. The conditional branching flag detecting unit 1215 repeats this while changing the number of times of branching, thereby detecting condition branching flags.

[Processing of Branching VM Command Detecting Unit]
Next, the processing of the branching VM command detecting unit 1222 will be described. The branching VM command detecting unit 1222 detects branching VM commands by analyzing logs in acquired VM execution traces. It is sufficient for the test script here to contain a branching VM command, and accordingly may be any script as long as a script that contains a control syntax for branching. Test scripts are prepared by collecting from the Internet, acquiring from official documentation, and so forth, for example.

First, the branching VM command detecting unit 1222 acquires VM command opcode and VPC offset before and after command execution, as a set, from a VM execution trace. This offset o is calculated by o=pₙₑₓₜ−pₚᵣₑᵥ, with the value of the VPC before executing the command as pₚᵣₑᵥ, and the value of the VPC after executing the command as pₙₑₓₜ.

Now, when a certain VM command is a branching command, this offset changes dependent on the branching destination. Conversely, when the VM command is other than a branching command, the offset changes dependent on the size of the VM command. Accordingly, when the set of the opcode and the offset of the VM command is collected, and the offset value for each opcode is examined, the value of this offset will vary into various values depending to the branching destination, if this VM command is a branching command. Conversely, if this VM command is other than a branching command, the value of this offset will be concentrated on a particular value that is the size of the VM command.

Accordingly, the branching VM command detecting unit 1222 uses variance s to evaluate the degree of varying of the offset. With a set O of offsets as to a certain opcode as O={o₀, o₁, . . . , o_{N}} (see Expression (1) for average of offset o) and t as a threshold value, whether or not a branching command is determined as in Expression (3), on the basis of the variance s (see Expression (2)). Thus, the branching VM command detecting unit 1222 detects branching VM commands.

$$\begin{matrix}[ Math 1 ] & \\ \overline{o} = \frac{1}{N} {\sum }_{k = 0}^{N} {o}_{k} & ( 1 )\end{matrix}$$

$$\begin{matrix}[ Math 2 ] & \\ {s}^{2} = \frac{1}{N} {\sum }_{k = 0}^{N} {( {o}_{k} - \overline{o} )}^{2} & ( 2 )\end{matrix}$$

$$\begin{matrix}[ Math 3 ] & \\ IsBranch ( O ) = \{ \begin{matrix}true & ( s > 1 ) \\ fals e & ( o t h e r w i s e )\end{matrix} & ( 3 )\end{matrix}$$

Note that in VM commands other than branching, hardly any varying is observed, and the boundary between branching VM commands and other VM commands often is clear. Accordingly, the obtained values of variance are plotted on a number line, for example, and a value that can divide the two groups that are formed is set as the threshold value.

[Processing of Analysis Function Imparting Unit]
Next, processing of the analysis function imparting unit 123 will be described. The analysis function imparting unit 123 accepts script engine binary and a hook point and a tap point detected in the processing so far as input. The analysis function imparting unit 123 performs hooking of the script engine with the hook point.

Now, the analysis function imparting unit 123 inserts code for analyzing when hooking, so that a language element corresponding to the hook is executed, and log output of memory of the tap point serving as an argument thereof is output. This code for analyzing can be easily generated as long as the hook point and tap point are known. Thus, log output of the behavior thereof is performed when the script is executed, and impartation of analysis functions is realized.

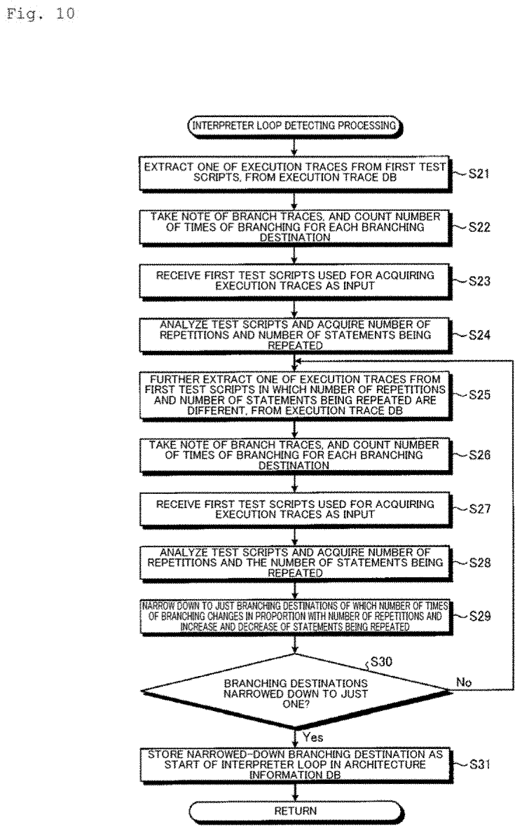

Imparting of the analysis functions by the hook may be realized by directly rewriting the binary of the script engine binary, or may be realized by rewriting the memory image when the binary is executed and loaded to process memory.

[Processing Procedures of Analysis Function Imparting Device]
Next, the processing procedures of analysis function imparting processing by the analysis function imparting device 10 will be described. FIG. 8 is a flowchart showing the processing procedures of analysis function imparting processing according to the embodiment.

First, the input unit 11 accepts the test scripts and the script engine binary as input (step S1).

The execution trace acquiring unit 1211 then performs execution trace acquiring processing of executing the test script while monitoring the binary of the script engine, and acquiring branch traces and memory access traces (step S2). The interpreter loop detecting unit 1212 then extracts and analyzes execution traces corresponding to the first test script, stored in the execution trace DB 131, and performs interpreter loop detecting processing of discovering interpreter loops (step S3).

The virtual program counter detecting unit 1213 extracts and analyzes execution traces corresponding to the first test script, stored in the execution trace DB 131, and performs virtual program counter detecting processing of discovering VPCs (step S4). The decoder/dispatcher detecting unit 1214 performs predetermined static analysis on the script engine binary, thereby performing decoder/dispatcher detecting processing of detecting Switch statements, function tables, and jump tables present within the interpreter loops (step S5). The conditional branching flag detecting unit 1215 extracts and analyzes execution traces corresponding to the second test script, stored in the execution trace DB 131, and performs conditional branching detection processing of discovering conditional branching flags (step S6).

The VM execution trace acquiring unit 1221 accepts test scripts and script engine binary as input, and executes the test scripts while monitoring the script engine binary, thereby performing VM execution trace acquiring processing of acquiring VM execution traces (step S7). The branching VM command detecting unit 1222 extracts and analyzes VM execution traces stored in the VM execution trace DB 133, and performs branching VM command detecting processing of detecting branching VM commands (step S8).

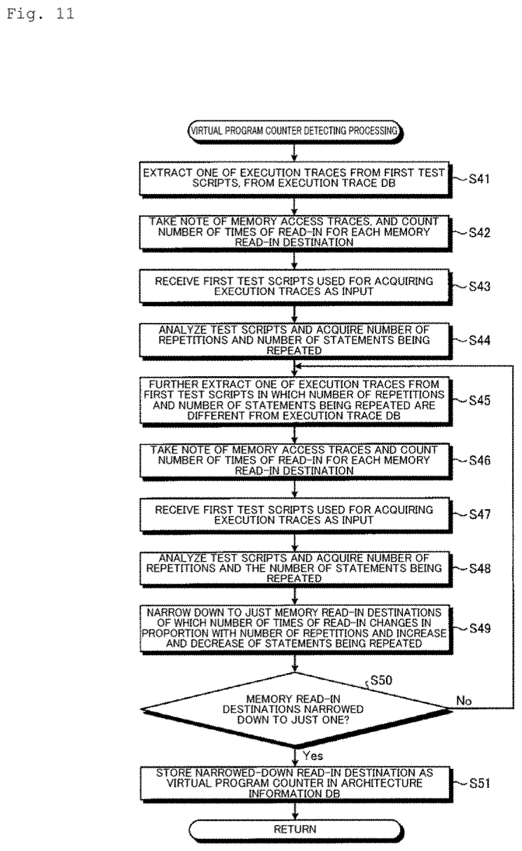

The analysis function imparting unit 123 performs analysis function imparting processing of hooking the script engine using the acquired VPCs, branching VM commands, and conditional branching flags (step S9). The output unit 14 then outputs the script engine binary to which multipath execution functions have been imparted (step S10).

[Processing Procedures of Execution Trace Acquiring Processing]
Next, the flow of execution trace acquiring processing shown in FIG. 9 will be described. FIG. 9 is a flowchart showing processing procedures of the execution trace acquiring processing shown in FIG. 8.

First, the execution trace acquiring unit 1211 receives the test scripts and the script engine binary as input (step S11). The execution trace acquiring unit 1211 then performs hooking of the received script engine for acquisition of branch traces (step S12). The execution trace acquiring unit 1211 also performs hooking of the received script engine for acquisition of memory access traces (step S13).

The execution trace acquiring unit 1211 then inputs the received test scripts into the script engine in this state, so as to be executed (step S14), and stores the execution traces acquired thereby in the execution trace DB 131 (step S15).

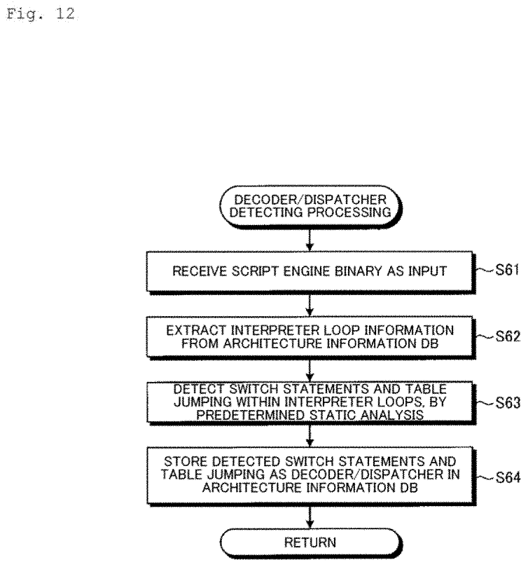

The execution trace acquiring unit 1211 determines whether or not execution of all of the input test scripts has ended (step S16). In a case where execution of all of the input test scripts has ended (Yes in step S16), the execution trace acquiring unit 1211 ends the processing. Conversely, in a case where execution of all of the input test scripts has not ended (No in step S16), the execution trace acquiring unit 1211 returns to the test script execution in step S14, and continues the processing.

[Processing Procedures of Interpreter Loop Detecting Processing]
Next, the flow of interpreter loop detecting processing shown in FIG. 8 will be described. FIG. 10 is a flowchart showing processing procedures of the interpreter loop detecting processing shown in FIG. 8.

First, the interpreter loop detecting unit 1212 extracts one of the execution traces from the first test scripts, from the execution trace DB 131 (step S21). The interpreter loop detecting unit 1212 then takes note of branch traces out of the execution traces, and counts the number of times of branching for each branching destination (step S22). Next, the interpreter loop detecting unit 1212 receives the first test scripts used for acquiring the execution traces as input (step S23), performs analysis thereof, and acquires the number of repetitions thereof and the number of statements being repeated (step S24).

The interpreter loop detecting unit 1212 further extracts one of the execution traces from the first test scripts in which the number of repetitions thereof and the number of statements being repeated are different, from the execution trace DB 131 (step S25). The interpreter loop detecting unit 1212 then takes note of branch traces, and counts the number of times of branching for each branching destination (step S26). Also, the interpreter loop detecting unit 1212 receives the first test scripts used for acquiring the execution traces as input (step S27), performs analysis of the test scripts, and acquires the number of repetitions thereof and the number of statements being repeated (step S28).

The interpreter loop detecting unit 1212 then narrows down to just branching destinations regarding which the number of times of branching changes in proportion with the number of repetitions thereof and increase and decrease of statements being repeated (step S29). The interpreter loop detecting unit 1212 determines whether or not the branching destinations have been narrowed down to just one (step S30).

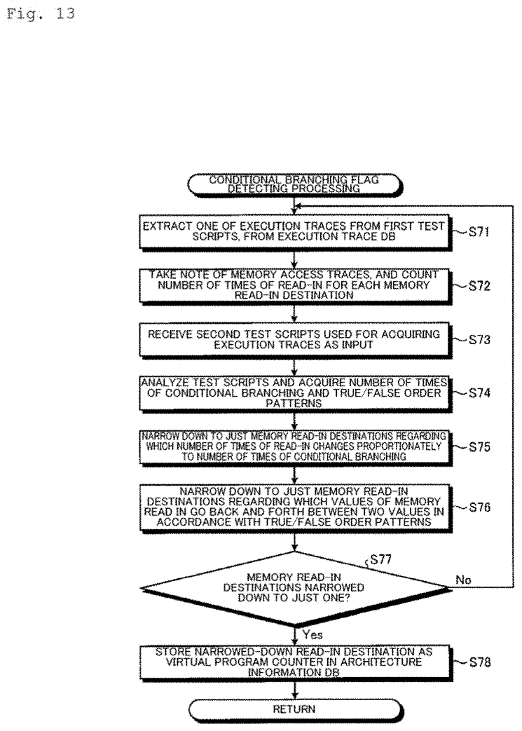

In a case where branching destinations have not been narrowed down to just one (No in step S30), the interpreter loop detecting unit 1212 returns to step S25, extracts one next execution trace, and continues processing. Conversely, in a case where branching destinations have been narrowed down to just one (Yes in step S30), the interpreter loop detecting unit 1212 stores the narrowed-down branching destination as the start of the interpreter loop, in the architecture information DB 132 (step S31), and ends the processing.

[Processing Procedures of Virtual Program Counter Detecting Processing]
Next, the flow of virtual program counter detecting processing shown in FIG. 8 will be described. FIG. 11 is a flowchart showing processing procedures of the virtual program counter detecting processing shown in FIG. 8.

First, the virtual program counter detecting unit 1213 extracts one of the execution traces from the first test scripts, from the execution trace DB 131 (step S41). Next, the virtual program counter detecting unit 1213 takes note of memory access traces out of the execution traces, and counts the number of times of read-in for each memory read-in destination (step S42).

The virtual program counter detecting unit 1213 receives the first test scripts used for acquiring the execution traces as input (step S43), performs analysis of these first test scripts, and acquires the number of repetitions thereof and the number of statements being repeated (step S44).

Next, the virtual program counter detecting unit 1213 further extracts one of the execution traces from the first test scripts in which the number of repetitions thereof and the number of statements being repeated are different, from the execution trace DB 131 (step S45). The virtual program counter detecting unit 1213 then takes note of memory access traces, and counts the number of times of read-in for each memory read-in destination (step S46). The virtual program counter detecting unit 1213 also receives the first test scripts used for acquiring the execution traces as input (step S47), performs analysis of the test scripts, and acquires the number of repetitions thereof and the number of statements being repeated (step S48).

Now, the virtual program counter detecting unit 1213 narrows down to just memory read-in destinations regarding which the number of times of read-in changes in proportion with the number of repetitions thereof and increase and decrease of statements being repeated (step S49).

The virtual program counter detecting unit 1213 then determines whether or not the memory read-in destinations have been narrowed down to just one (step S50). In a case where the memory read-in destinations have not been narrowed down to just one (No in step S50), the virtual program counter detecting unit 1213 returns to step S45, extracts one next execution trace, and continues processing. Conversely, in a case where memory read-in destinations have been narrowed down to just one (Yes in step S50), the virtual program counter detecting unit 1213 stores the narrowed-down memory read-in destination as the virtual program counter, in the architecture information DB 132 (step S51), and ends the processing.

[Processing Procedures of Decoder/Dispatcher Detecting Processing]
Next, the flow of decoder/dispatcher detecting processing shown in FIG. 8 will be described. FIG. 12 is a flowchart showing processing procedures of the decoder/dispatcher detecting processing shown in FIG. 8.

First, the decoder/dispatcher detecting unit 1214 receives the script engine binary as input (step S61). The decoder/dispatcher detecting unit 1214 then extracts interpreter loop information from the architecture information DB 132 (step S62).

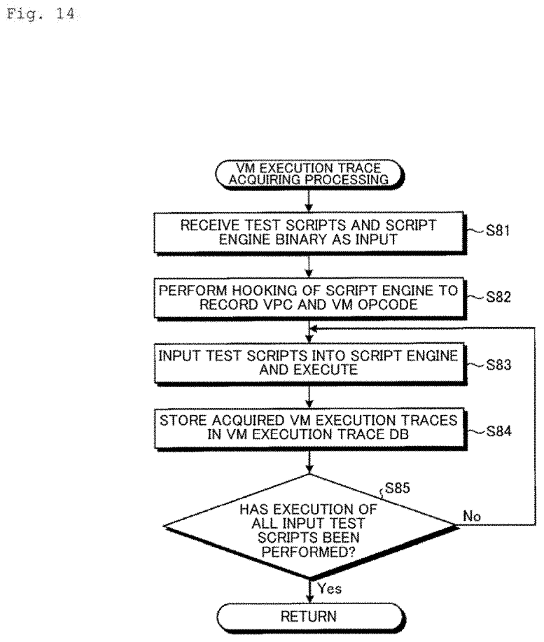

Next, the decoder/dispatcher detecting unit 1214 detects Switch statements and table jumping within interpreter loops, by predetermined static analysis (step S63). The decoder/dispatcher detecting unit 1214 stores the detected Switch statements and table jumping as the decoder/dispatcher, in the architecture information DB 132 (step S64), and ends the processing.

[Processing Procedures of Conditional Branching Flag Detecting Processing]
Next, the flow of conditional branching flag detecting processing shown in FIG. 8 will be described. FIG. 13 is a flowchart showing processing procedures of the conditional branching flag detecting processing shown in FIG. 8.

First, the conditional branching flag detecting unit 1215 extracts one of the execution traces from the second test scripts, from the execution trace DB 131 (step S71). Next, the conditional branching flag detecting unit 1215 takes note of memory access traces, and counts the number of times of read-in for each memory read-in destination (step S72).

The conditional branching flag detecting unit 1215 also receives the second test scripts used for acquiring the execution traces as input (step S73), performs analysis of these second test scripts, and acquires the number of times of conditional branching, and True/False order patterns (step S74). The conditional branching flag detecting unit 1215 then narrows down to just memory read-in destinations regarding which the number of times of read-in changes proportionately to the number of times of conditional branching (step S75). The conditional branching flag detecting unit 1215 further narrows down to just memory read-in destinations regarding which the values of memory read in go back and forth between two values in accordance with True/False order patterns (step S76).

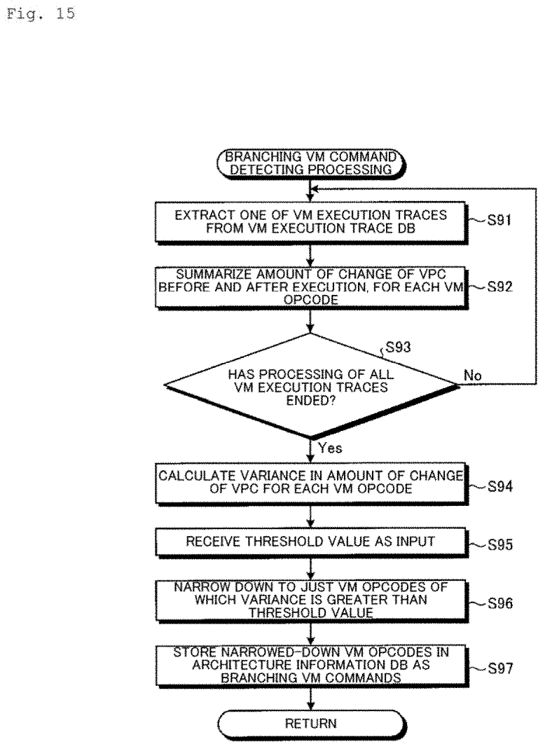

The conditional branching flag detecting unit 1215 determines whether or not the memory read-in destinations have been narrowed down to just one (step S77). In a case where the memory read-in destinations have not been narrowed down to just one (No in step S77), the conditional branching flag detecting unit 1215 returns to step S71, extracts one next execution trace, and continues processing. Conversely, in a case where the memory read-in destinations have been narrowed down to just one (Yes in step S77), the conditional branching flag detecting unit 1215 stores the narrowed-down read-in destination as the virtual program counter, in the architecture information DB 132 (step S78), and ends the processing.

[Processing Procedures of VM Execution Trace Acquiring Processing]
Next, the flow of VM execution trace acquiring processing shown in FIG. 8 will be described. FIG. 14 is a flowchart showing processing procedures of the VM execution trace acquiring processing shown in FIG. 8.

First, the VM execution trace acquiring unit 1221 receives the test scripts and the script engine binary as input (step S81). The VM execution trace acquiring unit 1221 then performs hooking of the received script engine to record the VPC and VM opcode (step S82).

The VM execution trace acquiring unit 1221 inputs the received test scripts into the script engine in this state, so as to be executed (step S83), and stores the VM execution traces acquired thereby in the VM execution trace DB 133 (step S84).

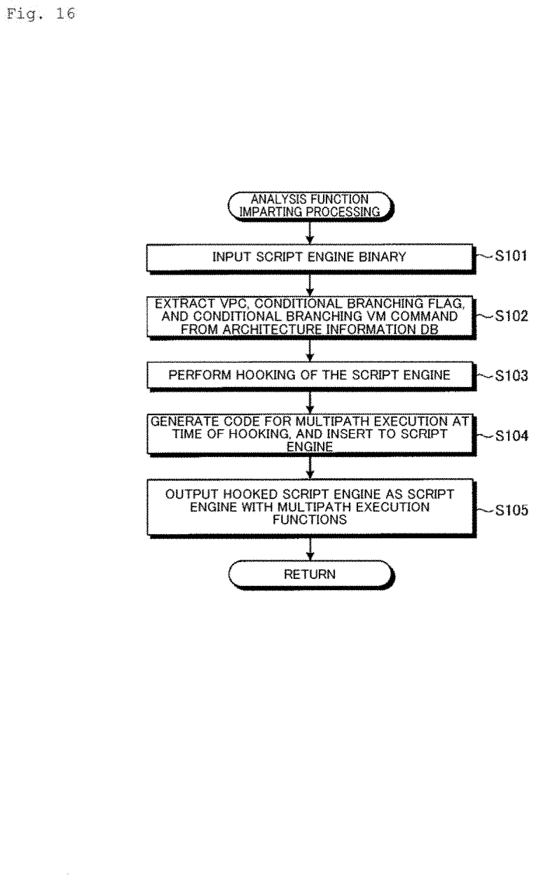

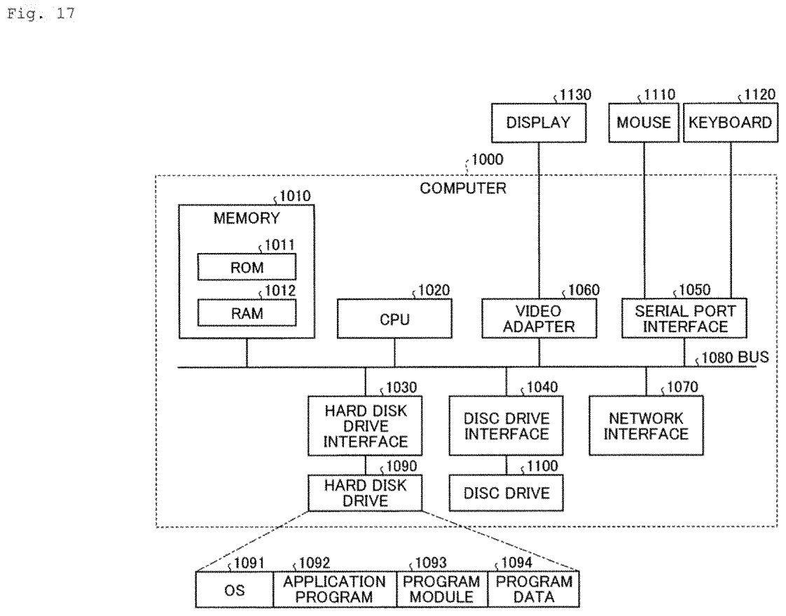

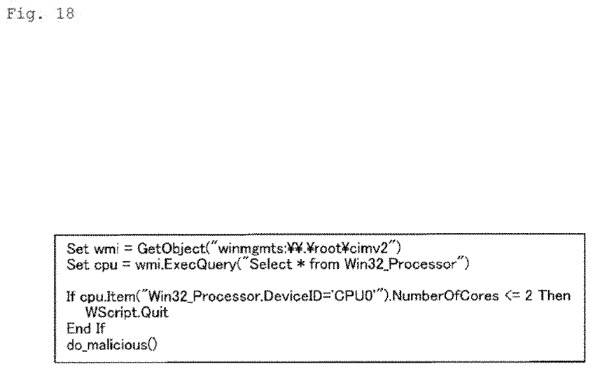

The VM execution trace acquiring unit 1221 determines whether or not execution of all of the input test scripts has been performed (step S85). In a case where execution of all of the input test scripts has ended (Yes in step S85), the VM execution trace acquiring unit 1221 ends the processing. In a case where execution of all of the input test scripts has not ended (No in step S85), the VM execution trace acquiring unit 1221 returns to the test script execution in step S83, and continues the processing.

[Processing Procedures of Branching VM Command Detecting Processing]
Next, the flow of branching VM command detecting processing shown in FIG. 8 will be described. FIG. 15 is a flowchart showing processing procedures of the branching VM command detecting processing shown in FIG. 8.

First, the branching VM command detecting unit 1222 extracts one of the VM execution traces from the VM execution trace DB 133 (step S91). The branching VM command detecting unit 1222 then summarizes the amount of change of the VPC before and after execution, for each VM opcode (step S92).

The branching VM command detecting unit 1222 determines whether or not processing of all VM execution traces in the VM execution trace DB 133 has ended (step S93). In a case where processing of all VM execution traces in the VM execution trace DB 133 has not ended (No in step S93), the branching VM command detecting unit 1222 returns to step S91, extracts one next VM execution trace, and performs processing thereof.

In a case where processing of all VM execution traces in the VM execution trace DB 133 has ended (Yes in step S93), the branching VM command detecting unit 1222 calculates the variance in the amount of change of the VPC for each VM opcode (step S94). The branching VM command detecting unit 1222 then receives a threshold value as input (step S95). The branching VM command detecting unit 1222 narrows down to just VM opcodes of which the variance is greater than the threshold value (step S96), stores these in the architecture information DB 132 as branching VM commands (step S97), and ends the processing.

[Processing Procedures of Analysis Function Imparting Processing]
Next, the flow of analysis function imparting processing shown in FIG. 8 will be described. FIG. 15 is a flowchart showing processing procedures of the analysis function imparting processing shown in FIG. 8.

First, the analysis function imparting unit 123 receives the script engine binary as input (step S101). The analysis function imparting unit 123 then extracts the VPC, the conditional branching flag, and the conditional branching VM command from the architecture information DB 132 (step S102). Next, the analysis function imparting unit 123 performs hooking of the hook point of the script engine (step S103). The analysis function imparting unit 123 generates code which is inserted to the script engine, so that multipath execution code will be executed, at the time of this hooking (step S104). The analysis function imparting unit 123 outputs the script engine acquired by being hooked in this way as a script engine with multipath execution functions (step S105), and ends the processing.

[Advantages of Embodiment]
In this way, the analysis function imparting device 10 according to the present embodiment analyzes the VM of the script engine, analyzes the command set architecture that is the command system of the VM, and performs hooking of the script engine to impart multipath execution functions, on the basis of the architecture information acquired by these analyses.

Specifically, the analysis function imparting device 10 executes test scripts while monitoring the binary of the script engine, and acquires branch traces and memory access traces. The analysis function imparting device 10 analyzes the virtual machine on the basis of these execution traces, and acquires architecture information of interpreter loops, VPCs, decoder/dispatchers, and conditional branching flags. The analysis function imparting device 10 further executes test scripts and acquires VM execution traces, and analyzes the command set architecture using these VM execution traces, thereby acquiring branching VM commands as architecture information. Thereafter, the analysis function imparting device 10 imparts multipath execution functions to the script engine, on the basis of the acquired architecture information.

Accordingly, the analysis function imparting device 10 can detect various types of architecture information by analysis based on acquisition of execution traces and VM execution traces, and can realize impartation of multipath execution functions without necessitating manual reverse engineering, even for proprietary script engines regarding which only the binary is available.

Also, the analysis function imparting device 10 can automatically impart multipath execution functions to a wide variety of script engines, as long as test scripts are provided, and accordingly impartation of multipath execution functions can be realized without necessitating individual design and execution.

Further, the analysis function imparting device 10 takes into consideration detailed architecture such as conditional branching and so forth, and accordingly impartation of multipath execution functions can be realized that is accurate with regard to conditional branching in the script.

In this way, according to the analysis function imparting device 10, automatic impartation of multipath execution functions can be realized regarding script engines of a wide variety of script languages, by analyzing the script engine and retrofit-imparting of multipath execution functions.

As described above, the analysis function imparting device 10 is useful in analyzing the behavior of malicious script described in a wide variety of script languages, and is suitable for comprehensively analyzing behavior of malicious script having paths that are not executed unless particular conditions are satisfied, without being affected thereby. Accordingly, imparting multipath execution functions to various script engines using the present embodiment can be utilized in measures such as analyzing and detecting behavior of malicious script.

[About System Configuration of Embodiment]
The components of the analysis function imparting device 10 illustrated in FIG. 3 are functional concepts, and do not need to be physically configured in the same way as illustrated in the figures. That is to say, specific forms of distribution and integration of the functions of the analysis function imparting device 10 are not limited to those illustrated in the figures, and all or part thereof can be configured being functionally or physically distributed or integrated in optional increments, in accordance with various types of loads, usage states, and so forth.

Also, all or an optional part of the processing carried out at the analysis function imparting device 10 may be realized by a CPU and a program analyzed and executed by the CPU, or alternatively may be realized as hardware through wired logic.

Also, out of the processes described in the present embodiment, all or part of processes described as being automatically performed can be manually performed. Alternatively, all or part of processes described as being manually performed can be automatically performed by known methods. Moreover, processing procedures, control procedures, specific names, and information including various types of data and parameters, in the above description and the figures, can be optionally changed unless specifically stated otherwise.

[Program]
FIG. 17 is a diagram illustrating an example of a computer that realizes the analysis function imparting device 10 by executing a program. A computer 1000 has memory 1010 and a CPU 1020, for example. The computer 1000 also has a hard disk drive interface 1030, a disc drive interface 1040, a serial port interface 1050, a video adapter 1060, and a network interface 1070. These parts are connected by a bus 1080.

The memory 1010 includes ROM 1011 and RAM 1012. The ROM 1011 stores a boot program such as a BIOS (Basic Input Output System), for example. The hard disk drive interface 1030 is connected to a hard disk drive 1090. The disc drive interface 1040 is connected to a disc drive 1100. A detachable storage medium such as a magnetic disk or an optical disc or the like, for example, is inserted to the disc drive 1100. The serial port interface 1050 is connected to, for example, a mouse 1110 and a keyboard 1120. The video adapter 1060 is connected to a display 1130, for example.

The hard disk drive 1090 stores, for example, an OS 1091, an application program 1092, a program module 1093, and program data 1094. That is to say, a program that defines each processing of the analysis function imparting device 10 is implemented as the program module 1093 in which code that is executable by the computer 1000 is described. The program module 1093 is stored in the hard disk drive 1090, for example. The program module 1093 for executing processing the same as the functional configurations of the analysis function imparting device 10, for example, is stored in the hard disk drive 1090. Note that the hard disk drive 1090 may be substituted by an SSD (Solid State Drive).

Also, settings data used in processing in the above-described embodiment is stored in the memory 1010 or the hard disk drive 1090, for example, as the program data 1094. The CPU 1020 then reads out the program module 1093 and the program data 1094 stored in the memory 1010 or the hard disk drive 1090 to the RAM 1012 as necessary, and performs execution thereof.

Note that the program module 1093 and the program data 1094 are not limited to a case of being stored in the hard disk drive 1090, and may be stored in a detachable storage medium for example, and be read out by the CPU 1020 via the disc drive 1100 or the like. Alternatively, the program module 1093 and the program data 1094 may be stored in another computer connected via a network (LAN (Local Area Network), WAN (Wide Area Network), or the like). The program module 1093 and the program data 1094 may then be read out from the other computer by the CPU 1020 via the network interface 1070.

Although an embodiment to which the invention made by the present inventor is applied has been described above, the present invention is not limited by descriptions and figures making up part of the disclosure of the present invention by way of the present embodiment. That is to say, all other embodiments, examples, operation technology, and so forth, made by one skilled in the art or the like based on the present embodiment, are encompassed by the scope of the present invention.

### REFERENCE SIGNS LIST

1 Script engine
2 Byte code compiler
3 Virtual machine (VM)

### 4 Parser

5 Byte code generator
6 Code cache unit
7 Fetch unit
8 Decoding unit
9 Executing unit
10 Analysis function imparting device
11 Input unit
12 Control unit
13 Storage unit
14 Output unit
121 Virtual machine analyzing unit
122 Command set architecture analyzing unit
123 Analysis function imparting unit
131 Execution trace database (DB)
132 Architecture information DB
133 VM execution trace DB
1211 Execution trace acquiring unit
1212 Interpreter loop detecting unit
1213 Virtual program counter detecting unit
1214 Decoder/dispatcher detecting unit
1215 Conditional branching flag detecting unit
1221 VM execution trace acquiring unit
1222 Branching VM command detecting unit

1-8. (canceled)

9. An analysis function imparting device, comprising:
first analyzing circuitry configured to analyze a virtual machine of a script engine;
second analyzing circuitry configured to analyze a command set architecture that is a command system of the virtual machine; and
imparting circuitry configured to perform hooking for imparting multipath execution functions to the script engine, on the basis of architecture information acquired by the analysis performed by the first analyzing circuitry and the second analyzing circuitry.

10. The analysis function imparting device according to claim 9, wherein:
the architecture information is a virtual program counter that is an object address read out from memory each time a command of the virtual machine is executed,
a conditional branching flag that is a region holding a flag of whether or not branching is performed at a time of conditional branching of an execution state, and
a branching virtual machine command that is a virtual machine command for generating a branch of the execution state.

11. The analysis function imparting device according to claim 9, wherein the first analyzing circuitry and the second analyzing circuitry carry out analysis using a test script.

12. The analysis function imparting device according to claim 10, wherein the first analyzing circuitry:
includes first acquiring circuitry configured to acquire a plurality of execution traces by changing conditions at the time of execution,
analyzes the plurality of execution traces using difference execution analysis, and
acquires the virtual program counter and the conditional branching flag.

13. The analysis function imparting device according to claim 12, wherein the first analyzing circuitry further includes:
first detecting circuitry configured to analyze the plurality of execution traces and detects an interpreter loop;
second detecting circuitry configured to use difference execution analysis that takes note of a count of times of memory read-in to analyze the plurality of execution traces, and detects the virtual program counter;
third detecting circuitry configured to perform static analysis of a binary of the script engine and detects a decoder/dispatcher; and
fourth detecting circuitry configured to use difference execution analysis that takes note of a count of times of memory read-in to analyze the plurality of execution traces, and detects the conditional branching flag.

14. The analysis function imparting device according to claim 10, wherein the second analyzing circuitry further includes:
acquiring circuitry that acquires a virtual machine execution trace that is an execution trace executed at the virtual machine, and
detecting circuitry that detects the branching virtual machine command from varying change amounts of virtual program counters for each virtual machine opcode of the virtual machine execution trace.

15. An analysis function imparting method executed by an analysis function imparting device, the method comprising:
a first analyzing process of analyzing a virtual machine of a script engine;
a second analyzing process of analyzing a command set architecture that is a command system of the virtual machine; and
an imparting process of performing hooking for imparting multipath execution functions to the script engine, on the basis of architecture information acquired in the analysis performed in the first analyzing process and the second analyzing process.

16. A non-transitory computer readable medium storing an analysis function imparting program for causing a computer to execute:
a first analyzing step of analyzing a virtual machine of a script engine,
a second analyzing step of analyzing a command set architecture that is a command system of the virtual machine, and
an imparting step of performing hooking for imparting multipath execution functions to the script engine, on the basis of architecture information acquired in the analysis performed in the first analyzing step and the second analyzing step.
